(19) United States
(12) Patent Application Publication
(10) Pub. No.: US 2026/0312299 A1
(43) Pub. Date: Oct. 8, 2026

(54) CELLULAR COMMUNICATION SYSTEMS HAVING ANTENNA ARRAYS THEREIN THAT PROVIDE NARROWED AZIMUTH BEAMWIDTH WITH IMPROVED GAIN

(71) Applicant: Outdoor Wireless Networks LLC, Richardson, TX (US)

(72) Inventors: Kamalakar Yeddula, Andhra Pradesh (IN); Ligang Wu, Suzhou (CN); Kumara Swamy Kasani, GodavariKahani (CN)

(21) Appl. No.: 19/480,469

(22) PCT Filed: May 24, 2023
(86) PCT No.: PCT/CN2023/095960

§ 371 Date: Oct. 31, 2025

(51) Int. Cl. H01Q 25/00; H01Q 1/24; H01Q 21/06

(52) U.S. Cl. CPC H01Q 25/002; H01Q 1/246; H01Q 21/061

(57) ABSTRACT

An antenna includes a three-column array of radiating elements having first and second L-grid sub-arrays therein that span the same rows of the array. The first sub-array has two radiating elements in a first column, and a radiating element in a second column; the second sub-array has two radiating elements in a third column, and a radiating element in the second column. A first hybrid coupler is provided, which includes: (i) a first input port responsive to a first RF feed signal, (ii) a second input port responsive to a second RF feed signal, (iii) a first output port configured to generate a first sub-array feed signal, which is provided to the first sub-array of radiating elements as a sum of k₁ times the first RF feed signal and k₂ times the second RF feed signal, and (iv) a second output port configured to generate a second sub-array feed signal, which is provided to the second sub-array of radiating elements as a sum of k₁ times the second RF feed signal and k₂ times the first RF feed signal, where k₁ and k₂ are positive numbers, k₁>k₂, k₁+k₂≤1, 0.85≤k₁≤0.95, and 0.05≤k₂≤0.15.

### FIELD OF THE INVENTION

The present invention relates to radio communication systems and, more particularly, to base station antennas (BSAs) utilized in cellular and other communication systems.

### BACKGROUND

In a typical cellular communications system, a geographic area is often divided into a series of regions that are commonly referred to as “cells”, which are served by respective base stations. Each base station may include one or more base station antennas (BSAs) that are configured to provide two-way radio frequency (“RF”) communications with mobile subscribers that are within the cell served by the base station. In many cases, each base station is divided into “sectors.” In perhaps the most common configuration, a hexagonally shaped cell is divided into three 120° sectors, and each sector is served by one or more base station antennas, which generate radiation patterns that have an azimuth Half Power Beam Width (HPBW) of approximately 65° per sector. Typically, the base station antennas are mounted on a tower or other raised structure and the radiation patterns (a/k/a “antenna beams”) are directed outwardly therefrom. Base station antennas are often implemented as linear or planar phased arrays of radiating elements.

### SUMMARY

An antenna for base station and other applications provides relatively narrow azimuth beamwidth and improved gain, using an array of radiating elements that are arranged into at least two columns. According to some embodiments of the invention, an array of radiating elements includes: (i) a first sub-array of radiating elements having at least one radiating element in one of the at least two columns and at least another radiating element in another one of the at least two columns, and (ii) a second sub-array of radiating elements having at least one radiating element in one of the at least two columns and at least another radiating element in another one of the at least two columns. In addition, to support narrowed azimuth beamwidth and improved gain, a first hybrid coupler is provided. This first hybrid coupler includes a first input port responsive to a first RF feed signal, a second input port responsive to a second RF feed signal, a first output port configured to generate a first sub-array feed signal to the first sub-array of radiating elements, and a second output port configured to generate a second sub-array feed signal to the second sub-array of radiating elements.

According to some of these embodiments of the invention, the first sub-array of radiating elements consists of three radiating elements, two of which are in the same column and two of which are in the same row, and the second sub-array of radiating elements consists of three radiating elements, two of which are in the same column and two of which are in the same row. In addition, the first sub-array of radiating elements may span the same two rows as the second sub-array of radiating elements. Moreover, if the array of radiating elements includes three columns of radiating elements therein, then one of the radiating elements in the first sub-array may be in the same column as one of the radiating elements in the second sub-array. For example, when the first sub-array includes two radiating elements in a first of the three columns of the array and one radiating element in a second of the three columns, the second sub-array may include two radiating elements in a third of the three columns of the array and one radiating element in the second of the three columns.

According to additional embodiments of the invention, the array of radiating elements may further include: (i) a third sub-array of radiating elements having at least one radiating element in one of the at least two columns and at least another radiating element in another one of the at least two columns, and (ii) a fourth sub-array of radiating elements having at least one radiating element in one of the at least two columns and at least another radiating element in another one of the at least two columns, and these third and fourth sub-arrays may span different rows of the array relative to the radiating elements in the first and second sub-arrays. In addition, a second hybrid coupler may be provided, which includes a first input port responsive to a third RF feed signal, a second input port responsive to a fourth RF feed signal, a first output port configured to generate a third sub-array feed signal to the third sub-array of radiating elements, and a second output port configured to generate a fourth sub-array feed signal to the fourth sub-array of radiating elements.

According to further embodiments of the invention, an antenna having narrowed azimuth beamwidth with improved gain includes an array of radiating elements with at least three columns of radiating elements therein. This array includes a first sub-array of radiating elements having two radiating elements in a first of the three columns and a radiating element in a second of the three columns, and a second sub-array of radiating elements having two radiating elements in a third of the three columns and a radiating element in the second of the three columns. A first hybrid coupler is provided, which includes: (i) a first input port responsive to a first RF feed signal, (ii) a second input port responsive to a second RF feed signal, (iii) a first output port configured to generate a first sub-array feed signal, which is provided to the first sub-array of radiating elements as a sum of k₁ times the first RF feed signal and k₂ times the second RF feed signal, and (iv) a second output port configured to generate a second sub-array feed signal, which is provided to the second sub-array of radiating elements as a sum of k₁ times the second RF feed signal and k₂ times the first RF feed signal, where k₁ and k₂ are positive numbers, k₁>k₂ and k₁+k₂≤1. In some instances, the coefficients k₁ and k₂ may accord with the following relationships: 0.85<k₁≤0.95, and 0.05≤k₂≤0.15; however, other relationships may also be possible depending on coupler configuration and application.

The array of radiating elements may further include: a third sub-array of radiating elements having two radiating elements in the first of the three columns and a radiating element in the second of the three columns, and a fourth sub-array of radiating elements having two radiating elements in the third of the three columns and a radiating element in the second of the three columns. These radiating elements in the third and fourth sub-arrays span different rows of the array relative to the radiating elements in the first and second sub-arrays. In addition, a second hybrid coupler may be provided, which includes: (i) a first input port responsive to a third RF feed signal, (ii) a second input port responsive to a fourth RF feed signal, (iii) a first output port configured to generate a third sub-array feed signal, which is provided to the third sub-array of radiating elements as a sum of k₁ times the third RF feed signal and k₂ times the fourth RF feed signal, and (iv) a second output port configured to generate a fourth sub-array feed signal, which is provided to the fourth sub-array of radiating elements as a sum of k₁ times the fourth RF feed signal and k₂ times the third first RF feed signal. In some instances, the array of radiating elements may further include: a fifth sub-array of radiating elements having two radiating elements in the first of the three columns and a radiating element in the second of the three columns, and a sixth sub-array of radiating elements having two radiating elements in the third of the three columns and a radiating element in the second of the three columns. These radiating elements in the fifth and six sub-arrays span different rows of the array relative to the radiating elements in the first through fourth sub-arrays.

According to still further embodiments of the invention, first and second power dividers may be provided. In particular, a first 1:n power divider may be provided, which is configured to generate the first and third RF feed signals and a fifth RF feed signal, in response to a first RF input feed signal (IN1), where n is a positive integer greater than two, and a second 1:n power divider may be provided, which is configured to generate the second and fourth RF feed signals and a sixth RF feed signal, in response to a second RF input feed signal (IN2). The fifth sub-array of radiating elements may also be directly responsive to a fifth RF feed signal (without intervening coupler), and the sixth sub-array of radiating elements may be directly responsive to a sixth RF feed signal (without intervening coupler).

### BRIEF DESCRIPTION OF THE DRAWINGS

FIG. 1A is a front plan view of a three-column antenna array for 617-896 MHz, according to an embodiment of the invention.

FIG. 1B is top view of the antenna array of FIG. 1A.

FIG. 1C is a block schematic diagram of an antenna that provides relatively narrow azimuth beamwidth and improved gain, and includes the antenna array of FIGS. 1A-1B, according to an embodiment of the invention.

FIG. 2A is a top plan view of a 4-port hybrid coupler that may be used in the antenna of FIG. 1C.

FIGS. 2B-2C are bottom plan views of two different embodiments of the 4-port hybrid coupler of FIG. 2A.

### DETAILED DESCRIPTION

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

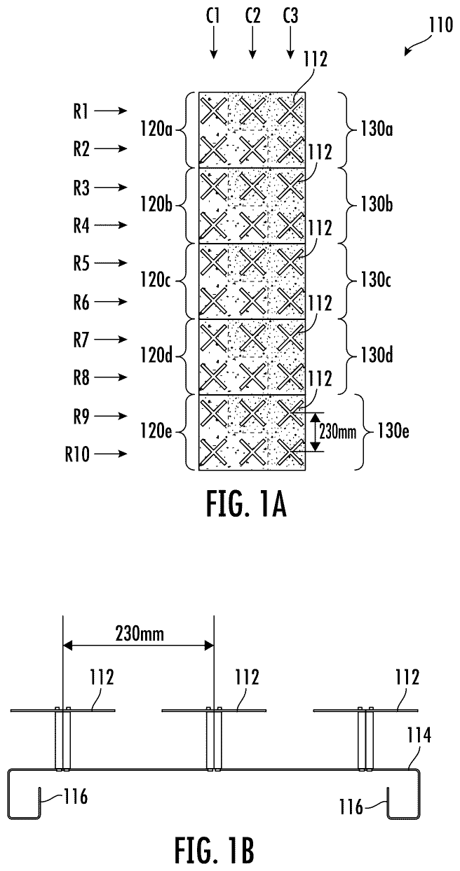

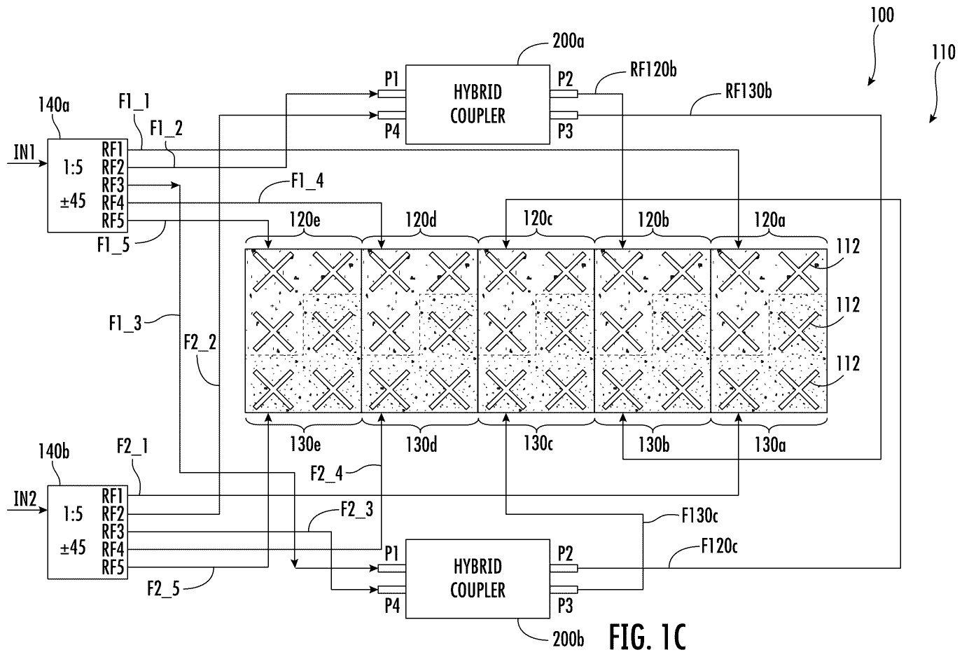

Referring now to FIGS. 1A-1C, an antenna 100 according to an embodiment of the invention is illustrated as including a two-dimensional array 110 of cross-polarized dipole radiating elements 112, which are mounted on a forward facing surface of an underlying reflector 114 with rearwardly-extending chokes 116. As shown, this array 110 is arranged into three columns (C1-C3) by ten rows (R1-R10) of radiating elements 112, which may be suitable for one or more frequency bands within a 617-896 MHz frequency range, for example. Moreover, to provide relatively narrow azimuth beamwidth and improved gain, the radiating elements 112 are arranged to have an equivalent row-to-row and column-to-column spacing of 230 mm, for example, and are partitioned into: (i) five left side sub-arrays 120a-120e of three radiating elements 112, and (ii) five right side sub-arrays 130a-130e of three radiating elements 112. On the left side of the array 110, the sub-arrays 120a-120e have an L-grid shape, and on the right side of the array 110, the sub-arrays 130a-130e have an upside-down (and backwards) L-grid shape.

Advantageously, and as shown by FIG. 1C, the azimuth beamwidth and gain of the array 110 may be improved by using one or more couplers (for each +45° and −45° polarization) to selectively partition the power of multiple RF feed signals between one or more sub-arrays on the left side of the array 110 and one or more corresponding sub-arrays on the right side of the array 110. In the illustrated embodiment, the RF feed signals (for each +45° and −45° polarization) are generated as F1_1-F1_5 by a first 1:5 power divider 140a, which is responsive to a first RF input feed signal (IN1), and as F2_1-F2_5 by a second 1:5 power divider 140b, which is responsive to a second RF input feed signal (IN2). Although not wishing to be bound by any configuration, the first and second 1:5 power dividers 140a, 140b may divide the power of the RF input feed signals (IN1, IN2) equally (i.e., 20% each) across the corresponding RF feed signals F1_1-F1_5 and F2_1-F2_5; however, other unequal power relationships are also applicable depending on application.

Moreover, according to some embodiments of the invention, a first four-port hybrid coupler 200a may be provided that converts one pair of distinct RF feed signals into a first pair of sub-array feed signals having predetermined contributions from each of the corresponding pair of RF feed signals. Similarly, a second four-port hybrid coupler 200b may be provided that converts another pair of distinct RF feed signals into a second pair of sub-array feed signals having predetermined contributions from each of the corresponding pair of RF feed signals. In particular, as shown, the first hybrid coupler 200a may be configured to include: (i) a first input port (P1) that is responsive to an RF feed signal F1_2, (ii) a second input port (P4) that is responsive to an RF feed signal F2_2, (iii) a first output port (P2) configured to generate a sub-array feed signal RF120b, which is provided to sub-array 120b as a sum of: k₁ times the RF feed signal F1_2 and k₂ times the RF feed signal F2_2, and (iv) a second output port (P3) configured to generate a sub-array feed signal RF130b, which is provided to sub-array 130b as a sum of: k₁ times the RF feed signal F2_2 and k₂ times the RF feed signal F1_2, where k₁ and k₂ are positive numbers, k₁>k₂ and k₁+k₂≤1. In some instances, the coefficients k₁ and k₂ may accord with the following relationships: 0.85≤k₁≤0.95, and 0.05≤k₂≤0.15; however, other relationships may also be possible depending on coupler configuration and application. Similarly, a second hybrid coupler 200b may be configured to include: (i) a first input port (P1) that is responsive to an RF feed signal F1_3, (ii) a second input port (P4) that is responsive to an RF feed signal F2_3, (iii) a first output port (P2) configured to generate a sub-array feed signal RF120c, which is provided to sub-array 120c as a sum of: k₁ times RF feed signal F1_3 and k₂ times RF feed signal F2_3, and (iv) a second output port (P3) configured to generate sub-array feed signal RF130c, which is provided to sub-array 130c as a sum of: k₁ times the RF feed signal F2_3 and k₂ times RF feed signal F1_3.

In contrast, and as illustrated below by Table 1, which illustrates how the feed signals generated by the power dividers 140a, 140b are provided to the antenna array 110 of FIG. 1C, the left side sub-arrays 120a, 120d and 120e are directly responsive to corresponding ones of the RF feed signals F1_1, F1_4 and F1_5, respectively, whereas the right side sub-arrays 130a, 130d and 130e are directly responsive to corresponding ones of the RF feed signals F2_1, F2_4 and F2_5, respectively, where the symbol “x” means “proportional to.”

TABLE 1

| ANTENNA ARRAY | COLUMN 1 | COLUMN 2 | COLUMN 3 |
|---|---|---|---|
| ROW 1 | ∝ F1_1 | ∝ F2_1 | ∝ F2_1 |
| ROW 2 | ∝ F1_1 | ∝ F1_1 | ∝ F2_1 |
| ROW 3 | ∝ (k₁ × F1_2 + k₂ × F2_2) | ∝ (k₁ × F2_2 + k₂ × F1_2) | ∝ (k₁ × F2_2 + k₂ × F1_2) |
| ROW 4 | ∝ (k₁ × F1_2 + k₂ × F2_2) | ∝ (k₁ × F1_2 + k₂ × F2_2) | ∝ (k₁ × F2_2 + k₂ × F1_2) |
| ROW 5 | ∝ (k₁ × F1_3 + k₂ × F2_3) | ∝ (k₁ × F2_3 + k₂ × F1_3) | ∝ (k₁ × F2_3 + k₂ × F1_3) |
| ROW 6 | ∝ (k₁ × F1_3 + k₂ × F2_3) | ∝ (k₁ × F1_3 + k₂ × F2_3) | ∝ (k₁ × F2_3 + k₂ × F1_3) |
| ROW 7 | ∝ F1_4 | ∝ F2_4 | ∝ F2_4 |
| ROW 8 | ∝ F1_4 | ∝ F1_4 | ∝ F2_4 |
| ROW 9 | ∝ F1_5 | ∝ F2_5 | ∝ F2_5 |
| ROW 10 | ∝ F1_5 | ∝ F1_5 | ∝ F2_5 |

In addition, as illustrated by Table 2, according to some additional embodiments of the invention, the “left side” sub-array feed signals F1_1, RF120b, RF120c, F1_4 and F1_5, and the “right side” sub-array feed signals F2_1, RF130b, RF130c, F2_4 and F2_5 may each be uniquely distributed to each of the radiating elements 112 in the corresponding 3-element sub-arrays 120a-120e and 130a-130e. For example, according to some embodiments, the thirty (30) power distribution coefficients n₁₁ to n₁₀₃ in Table 2 may be equivalent (e.g., ⅓=0.333); however, according to other embodiments, some of the power distribution coefficients may be unequal and uniquely tuned so as to achieve a desired beam pattern, beamwidth and/or gain for a particular application.

TABLE 2

| ANTENNA ARRAY | COLUMN 1 | COLUMN 2 | COLUMN 3 |
|---|---|---|---|
| ROW 1 | F1_1 ÷ n₁₁ | F2_1 ÷ n₁₂ | F2_1 ÷ n₁₃ |
| ROW 2 | F1_1 ÷ n₂₁ | F1_1 ÷ n₂₂ | F2_1 ÷ n₂₃ |
| ROW 3 | (k₁ × F1_2 + k₂ × F2_2) ÷ n₃₁ | (k₁ × F2_2 + k₂ × F1_2) ÷ n₃₂ | (k₁ × F2_2 + k₂ × F1_2) ÷ n₃₃ |
| ROW 4 | (k₁ × F1_2 + k₂ × F2_2) ÷ n₄₁ | (k₁ × F1_2 + k₂ × F2_2) ÷ n₄₂ | (k₁ × F2_2 + k₂ × F1_2) ÷ n₄₃ |
| ROW 5 | (k₁ × F1_3 + k₂ × F2_3) ÷ n₅₁ | (k₁ × F2_3 + k₂ × F1_3) ÷ n₅₂ | (k₁ × F2_3 + k₂ × F1_3) ÷ n₅₃ |
| ROW 6 | (k₁ × F1_3 + k₂ × F2_3) ÷ n₆₁ | (k₁ × F1_3 + k₂ × F2_3) ÷ n₆₂ | (k₁ × F2_3 + k₂ × F1_3) ÷ n₆₃ |
| ROW 7 | F1_4 ÷ n₇₁ | F2_4 ÷ n₇₂ | F2_4 ÷ n₇₃ |
| ROW 8 | F1_4 ÷ n₈₁ | F1_4 ÷ n₈₂ | F2_4 ÷ n₈₃ |
| ROW 9 | F1_5 ÷ n₉₁ | F2_5 ÷ n₉₂ | F2_5 ÷ n₉₃ |
| ROW 10 | F1_5 ÷ n₁₀₁ | F1_5 ÷ n₁₀₂ | F2_5 ÷ n₁₀₃ |

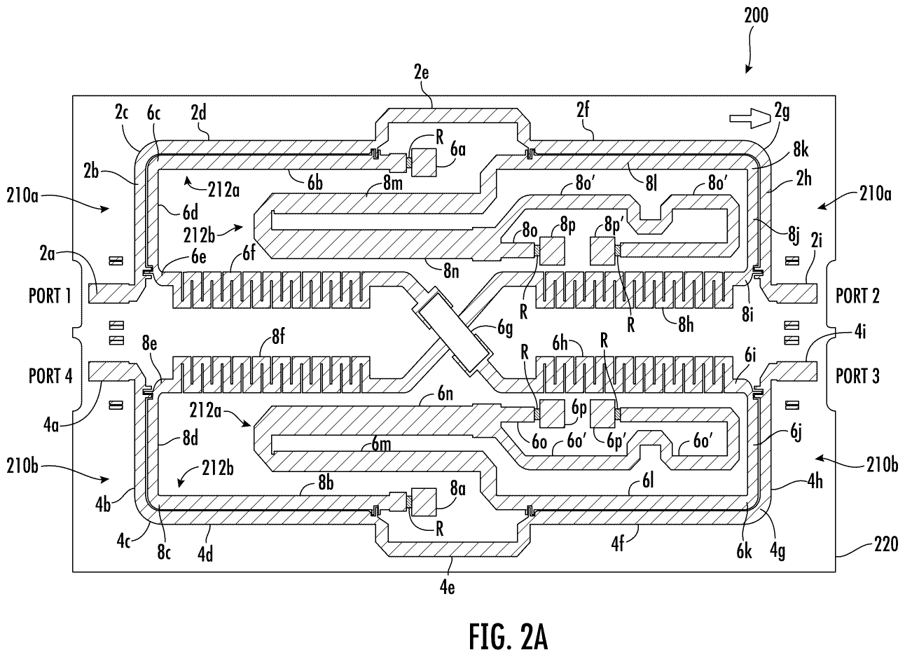

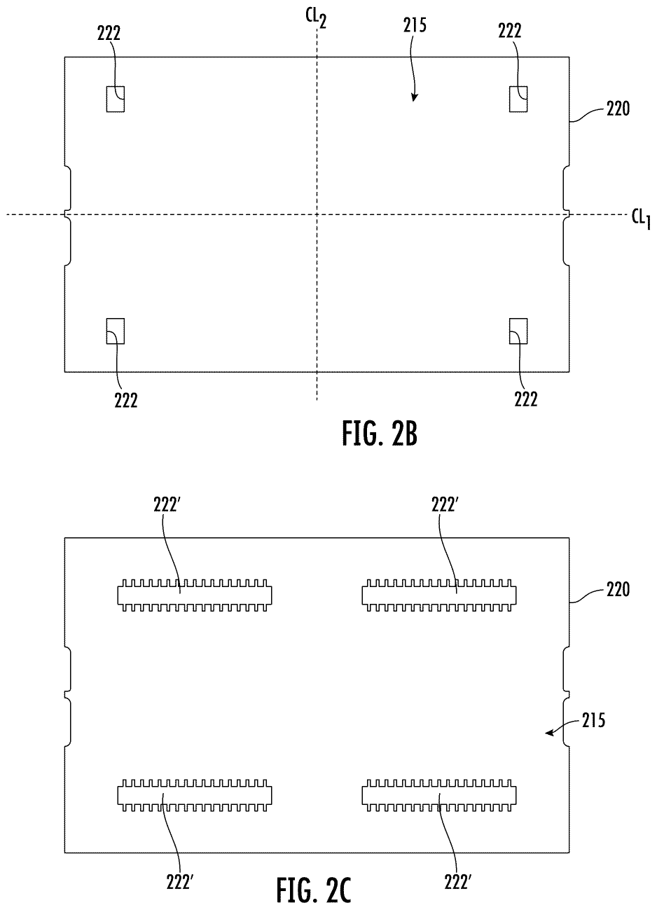

Referring now to FIGS. 2A-2C, one embodiment of the 4-port RF hybrid coupler 200 of FIG. 1C is illustrated as including a rectangular substrate 220, such as a PCB substrate, having top and bottom surfaces thereon. As shown by FIG. 2A, first and second primary traces 210a, 210b and first and second coupled traces 212a, 212b are provided as patterned metal traces on the top surface of the substrate 220, which may have relatively compact lateral dimensions of less than about 130 mm (length) by less than about 75 mm (width) to yield an area of less than about 10,000 mm². For example, in the illustrated embodiment, the rectangular substrate 220 may have reduced dimensions of about 115 mm×60 mm. Advantageously, these reduced dimensions may be achieved by locating a pair of ports on each side of the substrate 220 closer together and then using 90° and elbow-shaped trace segments within the first and second primary traces 210a, 210b and corresponding first and second coupled traces 212a, 212b to obtain a smaller overall trace layout “footprint” (while maintaining sufficient primary and coupled trace length), as described hereinbelow. The illustrated layout footprint may also be best suited for RF frequencies in a band from about 696 MHz to about 960 MHz, however, other frequency bands may also be used.

In addition, the first primary trace 210a has first and second ends electrically connected to first and second ports of the coupler 200, respectively, which are shown as Port 1 and Port 2, and the second primary trace 210b has first and second ends electrically connected to fourth and third ports of the coupler 200, respectively, which are shown as Port 4 and Port 3. As described hereinabove with respect to FIGS. 1A-1C, Port 1 and Port 4 may function as first and second input ports, respectively, whereas Port 2 and Port 3 may function as first and second output ports, respectively.

The first coupled trace 212a has a first end that is RF coupled to the first end of the first primary trace 210a (adjacent Port 1) and a second end that is RF coupled to the second end of the second primary trace 210b (adjacent Port 3). Similarly, the second coupled trace 212b has a first end that is RF coupled to the first end of the second primary trace 210b (adjacent Port 4) and a second end that is RF coupled to the second end of the first primary trace 210a (adjacent Port 2). Moreover, as will be understood by those skilled in the art, each of the primary and coupled traces is configured as a corresponding plurality of metal trace segments of different shapes, lengths and widths, which are electrically connected in series between their respective ends, as shown.

Thus, in the illustrated embodiment, the first primary trace 210a is configured to include the following trace segments: a first port segment 2a, a first linear segment 2b, a first elbow-shaped segment 2c, a second linear segment 2d, a third linear segment 2e, a fourth linear segment 2f, a second elbow-shaped segment 2g, a fifth linear segment 2h, and a second port segment 2i. In addition, the first port segment 2a and the first linear segment 2b are joined by a 90° corner segment, the second linear segment 2d and third linear segment 2e are joined by a pairs of 90° corner segments, the third linear segment 2e and fourth linear segment 2f are joined by a pair of 90° corner segments, and the fifth linear segment 2h and the second port segment 2i are joined by a 90° corner segment, as illustrated. Likewise, the second primary trace 210b, which is a mirror-image of the first primary trace 210a (about a first centerline CL1), is configured to include the following trace segments: a fourth port segment 4a, a first linear segment 4b, a first elbow-shaped segment 4c, a second linear segment 4d, a third linear segment 4e, a fourth linear segment 4f, a second elbow-shaped segment 4g, a fifth linear segment 4h, and a third port segment 4i. In addition, the fourth port segment 4a and the first linear segment 4b are joined by a 90° corner segment, the second linear segment 4d and third linear segment 4e are joined by a pair of 90° corner segments, the third linear segment 4e and fourth linear segment 4f are joined by a pair of 90° corner segments, and the fifth linear segment 4h and the third port segment 4i are joined by a 90° corner segment, as illustrated.

Referring still to FIG. 2A, the first coupled trace 212a has: (i) a first end including a plurality of trace segments connected in series, which collectively provide a first degree of RF coupling to the first end of the first primary trace 210a adjacent Port 1 when the coupler 200 is active (i.e., operating with RF signals), and (ii) a second end including a plurality of trace segments connected in series, which collectively provide a third degree of RF coupling to the second end of the second primary trace 210b adjacent Port 3 when the coupler is active. As explained more fully hereinbelow, the first and second ends of the first coupled trace 212a are configured differently/asymmetrically such that the third degree of RF coupling is preferably less than the first degree of RF coupling.

Likewise, the second coupled trace 212b has: (i) a first end including a plurality of trace segments connected in series, which collectively provide a fourth degree of RF coupling to the first end of the second primary trace 210b adjacent Port 4 when the coupler 200 is active, and (ii) a second end including a plurality of trace segments connected in series, which collectively provide a second degree of RF coupling to the second end of the first primary trace 210a adjacent Port 2 when the coupler 200 is active. In addition, the first and second ends of the second coupled trace 212b are configured differently/asymmetrically such that the fourth degree of RF coupling is preferably less than the second degree of RF coupling.

In particular, the first end of the first coupled trace 212a is configured to include the following trace segments: a first end termination 6a, a first linear segment 6b, which is connected to the first end termination 6a by a resistor R, a first elbow-shaped segment 6c, a second linear segment 6d, a second elbow-shaped segment 6e, and a first serpentine-shaped segment 6f. In contrast, the second end of the first coupled trace 212a is configured to include the following trace segments: a pair of end terminations 6p, 6p′, which are electrically coupled by resistors R and unequal length metal traces 6o, 6o′ to a relatively wide first linear segment 6n, a second linear segment 6m, which is electrically connected by a pair of 90° corner segments to the relatively wide first linear segment 6n, a third linear segment 6l, which is electrically connected by a pair of 90° corner segments to the second linear segment 6m, a first elbow-shaped segment 6k, a fourth linear segment 6j, a second elbow-shaped segment 6i, and a second serpentine-shaped segment 6h, which is electrically connected by a jumper segment 6g to the first serpentine-shaped segment 6f. Advantageously, these paired serpentine-shaped segments have a slow wave characteristic that provides for sufficient phase compensation.

Likewise, the first end of the second coupled trace 212b is configured to include the following trace segments: a first end termination 8a, a first linear segment 8b, which is connected to the first end termination 8a by a resistor R, a first elbow-shaped segment 8c, a second linear segment 8d, a second elbow-shaped segment 8e, and a first serpentine-shaped segment 8f. In contrast, the second end of the second coupled trace 212b is configured to include the following trace segments: a pair of end terminations 8p, 8p′, which are electrically coupled by resistors R and unequal length metal traces 80, 80′ to a relatively wide first linear segment 8n, a second linear segment 8m, which is electrically connected by a pair of 90° corner segments to the relatively wide first linear segment 8n, a third linear segment 8l, which is electrically connected by a pair of 90° corner segments to the second linear segment 8m, a first elbow-shaped segment 8k, a fourth linear segment 8j, a second elbow-shaped segment 8i, and a second serpentine-shaped segment 8h, which is electrically connected (without a jumper segment) to the first serpentine-shaped segment 8f; however, the placement of the jumper segment 6g may be reversed between the first and second coupled traces in an alternative embodiment.

Based on these illustrated configurations of the first and second coupled traces 212a, 212b a mirror-image equivalency is present between the first coupled trace 212a and the second coupled trace 212b relative to the first centerline CL1. Nonetheless, an asymmetry in the degree of coupling is present between the ends of the first and second coupled traces 212a, 212b relative to the corresponding ends of the first and second primary traces 210a, 210b (and corresponding ports) because a mirror-image equivalency is not present between the first coupled trace 212a and the second coupled trace 212b relative to a second centerline CL2, which is located equidistant from Port 1, Port 4 on one side of the substrate 220 and Port 2, Port 3 on an opposite side of the substrate 220. Moreover, as will be understood by those skilled in the art, the coupled trace segments 2b-2d/6b-6d, 2f-2h/8k-8l, 4b-4d/8b-8d, 4f-4h/6k-6l may function as components of a power divider circuit, which includes a first cascaded pair of power dividers that are cross-coupled with a second cascaded pair of power dividers.

Next, as shown by FIG. 2B, a ground plane 215 may be provided that entirely covers the bottom surface of the substrate 220, with the exception of four rectangular-shaped cut-out regions 222, which extend opposite the corresponding and closely “paired” elbow-shaped segments (2c, 6c), (2g, 8k), (4c, 8c) and (4g, 6k) of the first and second primary traces 210a, 210b and the first and second coupled traces 212a, 212b on the top surface of the substrate 220, and provide for a defected ground structure (DGS). Although not wishing to be bound by any theory, the presence of these cut-out regions 222 may operate to: (i) reduce capacitance between the “paired” elbow-shaped segments (2c, 6c), (2g, 8k), (4c, 8c) and (4g, 6k) and the ground plane 215, and (ii) boost RF coupling between the primary and coupled traces. As shown by FIG. 2C, in another embodiment, the DGS may be configured as a quad-arrangement of ladder-shaped openings 222′ within the ground plane 215, which extend opposite corresponding linear trace segments within the first and second primary traces 210a, 210b and the first and second coupled traces 212a, 212b and provide for even lower capacitance and further boosted RF coupling relative to the embodiment of FIG. 2B.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An antenna, comprising:
an array of radiating elements having at least two columns therein, said array of radiating elements including:
a first sub-array of radiating elements having at least one radiating element in one of the at least two columns and at least another radiating element in a different one of the at least two columns; and
a second sub-array of radiating elements having at least one radiating element in one of the at least two columns and at least another radiating element in a different one of the at least two columns; and
a first hybrid coupler having a first input port responsive to a first RF feed signal, a second input port responsive to a second RF feed signal, a first output port configured to generate a first sub-array feed signal to the first sub-array of radiating elements, and a second output port configured to generate a second sub-array feed signal to the second sub-array of radiating elements.

2. The antenna of claim 1, wherein at least two radiating elements in the first sub-array are in the same column but in different rows, and at least two of radiating elements in the first sub-array are in the same row but in different columns.

3. The antenna of claim 2, wherein the first sub-array of radiating elements consists of three radiating elements, two of which are in the same column and two of which are in the same row.

4. The antenna of claim 2, wherein at least two radiating elements in the second sub-array are in the same column but in different rows, and at least two of radiating elements in the second sub-array are in the same row but in different columns.

5. The antenna of claim 4, wherein the first sub-array of radiating elements consists of three radiating elements, two of which are in the same column and two of which are in the same row; and wherein the second sub-array of radiating elements consists of three radiating elements, two of which are in the same column and two of which are in the same row.

6. The antenna of claim 5, wherein the first sub-array of radiating elements span the same two rows as the second sub-array of radiating elements.

7. The antenna of claim 6, wherein the array of radiating elements has three columns of radiating elements therein; and wherein one of the radiating elements in the first sub-array is in the same column as one of the radiating elements in the second sub-array.

8. The antenna of claim 7, wherein the first sub-array includes two radiating elements in a first of the three columns of the array and one radiating element in a second of the three columns; and wherein the second sub-array includes two radiating elements in a third of the three columns of the array and one radiating element in the second of the three columns.

9. The antenna of claim 1,
wherein the array of radiating elements further comprises:
a third sub-array of radiating elements having at least one radiating element in one of the at least two columns and at least another radiating element in another one of the at least two columns; and
a fourth sub-array of radiating elements having at least one radiating element in one of the at least two columns and at least another radiating element in another one of the at least two columns; and
wherein the radiating elements in the third and fourth sub-arrays span different rows of the array relative to the radiating elements in the first and second sub-arrays.

10. The antenna of claim 9, further comprising:
a second hybrid coupler having a first input port responsive to a third RF feed signal, a second input port responsive to a fourth RF feed signal, a first output port configured to generate a third sub-array feed signal to the third sub-array of radiating elements, and a second output port configured to generate a fourth sub-array feed signal to the fourth sub-array of radiating elements.

11. An antenna, comprising:
an array of radiating elements having three columns therein, said array of radiating elements including:
a first sub-array of radiating elements having two radiating elements in a first of the three columns and a radiating element in a second of the three columns; and
a second sub-array of radiating elements having two radiating elements in a third of the three columns and a radiating element in the second of the three columns; and
a first hybrid coupler having: (i) a first input port responsive to a first RF feed signal, (ii) a second input port responsive to a second RF feed signal, (iii) a first output port configured to generate a first sub-array feed signal, which is provided to the first sub-array of radiating elements as a sum of k₁ times the first RF feed signal and k₂ times the second RF feed signal, and (iv) a second output port configured to generate a second sub-array feed signal, which is provided to the second sub-array of radiating elements as a sum of k₁ times the second RF feed signal and k₂ times the first RF feed signal, where k₁ and k₂ are positive numbers, k₁>k₂ and k₁+k_{2≤1.}

12. The antenna of claim 11,
wherein the array of radiating elements further comprises:
a third sub-array of radiating elements having two radiating elements in the first of the three columns and a radiating element in the second of the three columns; and
a fourth sub-array of radiating elements having two radiating elements in the third of the three columns and a radiating element in the second of the three columns; and
wherein the radiating elements in the third and fourth sub-arrays span different rows of the array relative to the radiating elements in the first and second sub-arrays.

13. The antenna of claim 12, further comprising:
a second hybrid coupler having: (i) a first input port responsive to a third RF feed signal, (ii) a second input port responsive to a fourth RF feed signal, (iii) a first output port configured to generate a third sub-array feed signal, which is provided to the third sub-array of radiating elements as a sum of k₁ times the third RF feed signal and k₂ times the fourth RF feed signal, and (iv) a second output port configured to generate a fourth sub-array feed signal, which is provided to the fourth sub-array of radiating elements as a sum of k₁ times the fourth RF feed signal and k₂ times the third first RF feed signal.

14. The antenna of claim 13,
wherein the array of radiating elements further comprises:
a fifth sub-array of radiating elements having two radiating elements in the first of the three columns and a radiating element in the second of the three columns; and
a sixth sub-array of radiating elements having two radiating elements in the third of the three columns and a radiating element in the second of the three columns; and
wherein the radiating elements in the fifth and six sub-arrays span different rows of the array relative to the radiating elements in the first through fourth sub-arrays.

15. The antenna of claim 14, further comprising:
a first 1:n power divider configured to generate the first and third RF feed signals, in response to a first RF input feed signal, where n is a positive integer greater than two; and
a second 1:n power divider configured to generate the second and fourth RF feed signals, in response to a second RF input feed signal.

16. The antenna of claim 15,
wherein the fifth sub-array of radiating elements is directly responsive to a fifth RF feed signal, and the sixth sub-array of radiating elements is directly responsive to a sixth RF feed signal; and
wherein the first 1:n power divider is further configured to generate the fifth RF feed signal, and the second 1:n power divider is further configured to generate the sixth RF feed signal.

17. The antenna of claim 16,
wherein the array of radiating elements further comprises:
a seventh sub-array of radiating elements having two radiating elements in the first of the three columns and a radiating element in the second of the three columns; and
an eighth sub-array of radiating elements having two radiating elements in the third of the three columns and a radiating element in the second of the three columns;
wherein the radiating elements in the seventh and eight sub-arrays span different rows of the array relative to the radiating elements in the first through sixth sub-arrays; and
wherein the seventh sub-array of radiating elements is directly responsive to a seventh RF feed signal generated by the first 1:n power divider, and the eighth sub-array of radiating elements is directly responsive to an eighth RF feed signal generated by the second 1:n power divider.

18. The antenna of claim 11, wherein: 0.85≤k₁≤0.95, and 0.05≤k₂≤0.15.

19. The antenna of claim 11, wherein the first hybrid coupler comprises:
a substrate;
a first primary trace on a first surface of the substrate, said first primary trace having first and second ends electrically coupled to the first input port and the first output port, respectively;
a second primary trace on the first surface of the substrate, said second primary trace having first and second ends electrically coupled to second input port and the second output port, respectively;
a first coupled trace on the first surface of the substrate, said first coupled trace having: (i) a first end comprising a plurality of trace segments connected in series, which collectively provide a first degree of RF coupling to the first end of the first primary trace adjacent the first input port when the coupler is active, and (ii) a second end comprising a plurality of trace segments connected in series, which collectively provide a third degree of RF coupling to the second end of the second primary trace adjacent the second output port when the coupler is active, which is unequal to the first degree of RF coupling; and
a second coupled trace on the first surface of the substrate, said second coupled trace having: (i) a first end comprising a plurality of trace segments connected in series, which collectively provide a fourth degree of RF coupling to the first end of the second primary trace adjacent the second input port when the coupler is active, and (ii) a second end comprising a plurality of trace segments connected in series, which collectively provide a second degree of RF coupling to the second end of the first primary trace adjacent the first output port when the coupler is active, which is unequal to the fourth degree of RF coupling.

20. The antenna of claim 19, wherein the first and second input ports extend adjacent a first side of the substrate, and the first and second output ports extend adjacent a second side of the substrate, opposite the first side; wherein the first end of the first coupled trace is a mirror-image of a first end of the second coupled trace, relative to a first centerline extending between the first and second primary traces; and wherein the second end of the first coupled trace is a mirror-image of a second end of the second coupled trace, relative to the first centerline.
